(19) United States
(12) Patent Application Publication
(10) Pub. No.: US 2025/0002379 A1
(43) Pub. Date: Jan. 2, 2025

(54) SYSTEMS AND METHODS FOR TREATING CONTAMINATED WATER AS A SOURCE FOR HYDROGEN

(71) Applicant: WP&E Technologies and Solutions, LLC, Flowery Branch, GA (US)

(72) Inventor: Harikrishnan Parthasarathy, Flowery Branch, GA (US)

(21) Appl. No.: 18/759,948

(22) Filed: Jun. 30, 2024

Related U.S. Application Data
(60) Provisional application No. 63/524,443, filed on Jun. 30, 2023.

(51) Int. Cl. C02F 1/467; B01D 53/14; B01D 53/48; B01D 53/62; B01D 53/68; B01D 53/78; C01B 3/52; C01B 3/56; C02F 101/30; C02F 103/36

(52) U.S. Cl. CPC C02F 1/4672; B01D 53/1475; B01D 53/1493; B01D 53/48; B01D 53/62; B01D 53/685; B01D 53/78; C01B 3/52; C01B 3/56; B01D 2251/304; B01D 2251/306; B01D 2251/404; B01D 2251/602; B01D 2251/604; B01D 2252/20405; B01D 2252/20421; B01D 2252/20484; B01D 2253/104; B01D 2256/16; B01D 2257/20; B01D 2257/30; B01D 2257/504; C01B 2203/0415; C01B 2203/042; C01B 2203/0475; C01B 2203/0485; C02F 2101/30; C02F 2103/365; C02F 2201/009

(57) ABSTRACT

Systems and methods for treating contaminated water as a source for hydrogen is disclosed herein. A hydrogen-gas-containing gaseous byproduct from treating contaminated water is collected, and gases other than hydrogen are removed therefrom to form a hydrogen-rich gaseous product. The hydrogen-rich gaseous product may then be used as fuel to power the contaminated water treatment step.

### RELATED APPLICATION DATA

This application claims the benefit of priority to U.S. Provisional Patent Application No. U.S. 63/524,443, titled Systems and Method for Hydrogen, which was filed on Jun. 30, 2023, and which is incorporated by reference herein in its entirety.

### FIELD

This disclosure is directed to systems and methods for treating contaminated water as a source for hydrogen and, in particular, to systems and methods for treating contaminated water to generate, capture, and/or utilize gaseous byproducts, such as hydrogen gas that result from the treatment of contaminated water.

### BACKGROUND

Electrolysis is a known method for treating water to generate, capture, and/or utilize a gaseous byproduct. Electrolysis systems and methods use electricity to split water molecules into hydrogen and oxygen gas. However, electrolysis often times requires a clean aqueous stream(s), or water, that has been deionized, meaning all or substantially all impurities, minerals, and electrically-charged particles must be removed before the water can be used. Moreover, conventional electrolysis systems and methods are energy-intensive and generally not suitable for all applications, especially, for contaminated water or dirty water applications, due to their high operating costs and complexity.

Various other systems and methods have been developed for treating water and in particular, for treating contaminated water. For example, another approach to producing a gaseous byproduct(s) from contaminated water comprises the use of chemical reactions, such as steam reforming reactions or water-gas shift reactions. These reactions can generate hydrogen along with other gases like carbon dioxide and methane. However, the use of chemical reactions may involve the use of catalysts, high temperatures, and/or corrosive or caustic chemicals, which can impact the efficiency, efficacy, and scalability of these gas-production systems or methods.

Petroleum refining effluent (PRE), which is the contaminated water discharged from petroleum refineries, is typically burned to remove hydrocarbon components therein before it is released into the environment.

Contaminated “discharge water” (e.g., water volumes or streams periodically or continuously discharged to the sea or other body (ies) of water) that is emitted from “produced water” or “dirty water” production facilities and/or from “produced water” or “dirty water” processing facilities is highly regulated or becoming highly regulated. Moreover, the “discharge water” that is emitted from remote, “dirty water” production facilities, for example, from off shore oil or gas platforms, is highly regulated or becoming highly regulated.

In some aspects, oil or gas wells are considered “dirty water” “production facilities” in that they mainly or primarily produce/extract water that is not readily obtainable or that has been sequestered in a substrate or material, and that happens to have a small but economically valuable fraction that is oil and gas.

In some aspects, removing, capturing, and redirecting the oil and/or gas fraction is often time associated with one or more related industrial channels-of-trade, and/or associated with specific regulations and understandings of what is acceptable.

In some aspects, processing “dirty water”, e.g., what remains of the “produced water” after processing for the oil and gas, is often times associated with its own, different industrial channels-of-trade and/or with different regulations and understandings of what is acceptable.

Accordingly, there is a need in the art for systems and methods for treating contaminated water of all types to generate, capture, and/or utilize gaseous byproducts, particularly, hydrogen. Existing approaches have limitations in terms of energy consumption, process complexity, and byproduct management, and none of these approaches have provided a comprehensive solution that combines the features according to the present disclosure.

### SUMMARY

This summary is provided to introduce a selection of concepts or aspects in a simplified form that are further described below in the detailed description. This summary is not intended to identify key features or essential features of the claimed subject matter, nor is it intended to be used in isolation as an aid in determining the scope of the claimed subject matter.

Certain aspects according to the present disclosure are directed towards systems and methods for treating contaminated water to generate, capture, and/or utilize gaseous byproducts, and more particularly, towards generating and capturing hydrogen and/or other gaseous byproducts/products from contaminated water of all types (e.g., produced water, dirty water, discharge water, etc.) using electro-oxidation techniques.

In some aspects, using the systems and methods for treating contaminated water according to the present disclosure a hydrogen-rich gaseous product (e.g., a product comprising at least 98% hydrogen gas) and other valuable product(s) is obtained from the gaseous byproduct resulting from the treatment of the contaminated water.

In some aspects, a system is provided for treating contaminated water according to the present disclosure, comprising a titanium anode comprising a mixed metal oxide (MMO) coating, a titanium cathode, a channel between the anode and the cathode, and a power source to apply electricity across the channel, or to the anode and/or cathode.

In some aspects, the system comprises a plurality of anodes and a plurality of cathodes.

In some aspects, the MMO coating is iridium oxide.

In some aspects, the MMO coating comprises iridium oxide, ruthenium oxide, tantalum oxide, and platinum oxide.

In some aspects, the titanium cathode comprises an MMO coating.

In some aspects, a method is disclosed, which comprises at least the following steps: (1) treating contaminated water, wherein said treating produces a gaseous byproduct that comprises hydrogen gas and at least one other gas; and (2) removing the at least one other gas(es) from the gaseous byproduct to produce a hydrogen-rich gaseous product. In some cases, the method may further comprise a step (3) in which the hydrogen-rich gaseous product is used as fuel for a device configured to produce electricity from the hydrogen-rich gaseous product. The electricity produced by the device may, in some embodiments, may be used to power the treatment of contaminated water that occurs in step (1).

In some aspects, the hydrogen-rich gaseous product comprises 98% or more or 99% or more hydrogen gas.

In some aspects, the gaseous byproduct may comprise hydrogen and at least one gas selected from the following: a halogen gas (e.g., chlorine gas) or halogen-containing gas, oxygen gas, carbon dioxide gas, sulfur-containing gas, or any combinations thereof. In some embodiments, the gaseous byproduct may comprise hydrogen gas, chlorine gas, and carbon dioxide gas.

In some aspects, treating the contaminated water comprises removing water-soluble organics (WSOs) or water-soluble organic compounds (WSOCs) from the contaminated water.

In some embodiments, the contaminated water is a petroleum refining effluent (PRE) or any other type of contaminated water according to the present disclosure.

In embodiments where the gaseous byproduct comprises hydrogen gas and a halogen gas or halogen-containing gas (e.g., chlorine gas), the halogen gas or halogen-containing gas (e.g., chlorine gas) may be removed from the gaseous byproduct using lime (CaO), soda lime (CaO and NaOH), activated alumina, or a mixture of calcium hydroxide and potassium hydroxide.

In embodiments where the gaseous byproduct comprises hydrogen gas and carbon dioxide gas, the hydrogen dioxide gas may be removed from the gaseous byproduct using an amine-containing material.

In embodiments where the gaseous byproduct comprises sulfur-containing gas, e.g. hydrogen sulfide, the sulfur-containing gas may be removed using a caustic material.

In another aspect, a method is disclosed that comprises at least the following steps: (1) treating a petroleum refining effluent (PRE), wherein said treating produces a gaseous byproduct that comprises hydrogen gas, halogen gas or halogen-containing gas, carbon dioxide gas, and a sulfur-containing gas; (2) removing the halogen gas or halogen-containing gas, the carbon dioxide gas, and the sulfur-containing gas from the gaseous byproduct to produce a hydrogen-rich gaseous product; and (3) using the hydrogen-rich gaseous product to produce electricity.

In this method: the halogen gas or halogen-containing gas may be removed using lime (CaO), soda lime (CaO and NaOH), activated alumina, or a mixture of calcium hydroxide and potassium hydroxide; the carbon dioxide gas may be removed using an amine-containing material; and the sulfur-containing gas may be removed using a caustic material.

In this method, treating a petroleum refining effluent (PRE) may involve removal of water-soluble organics (WSOs) or water-soluble organic compounds (WSOCs) from the petroleum refining effluent (PRE) using an electro-oxidation process.

In this method, the electricity produced using the hydrogen-rich gaseous product may be used to power the electro-oxidation process.

In another aspect, a system is disclosed that comprises at least the following subsystems: (1) a subsystem configured for treating contaminated water, wherein a gaseous byproduct comprising hydrogen and at least one other gas(es) is produced by treating the contaminated water; (2) a subsystem configured for removing the at least one other gas from the gaseous byproduct to produce a hydrogen-rich gaseous product. In some embodiments, the system includes a further subsystem as follows: (3) a subsystem configured for using the hydrogen-rich gaseous product to produce electricity. The system may be configured to use the electricity produced in subsystem (3) to power subsystem (1), i.e., to power the treatment of the contaminated water.

In some aspects, the subsystem configured for removing the at least one other gas from the gaseous by product to produce a hydrogen-rich gaseous product may be made up of one or more units for performing this function. For example, a unit configured for removing halogen gas, a unit configured for removing sulfur-containing gas, and/or a unit configured for removing carbon dioxide gas.

In some aspects, the system comprises an electro-oxidation system/process including: a titanium anode coated with platinum, and a mixed metal oxide combination having two or more of ruthenium oxide, iridium (IV) oxide, tantalum oxide, or any combination thereof. For example, a mixed metal oxide, titanium anode and a titanium cathode connected to a voltage source. In some aspects, the mixed metal oxide, titanium anode is specifically coated in a mixed metal oxide combination (two or more mixed metal oxides, namely, those having rare earth metal elements) and platinum (distinguished from platinum oxide; platinum is a noble metal)

In some aspects, an electro-oxidation system/process including a coated titanium anode and an equivalently coated titanium cathode connected to a voltage source is provided. For example, the anode and the cathode are coated in a mixed metal oxide, namely, any of ruthenium oxide, iridium (IV) oxide, tantalum oxide, or those listed above and herein.

In some aspects, an electro-oxidation system/process including a mixed metal oxide and platinum, titanium anode, and a mixed metal oxide and platinum, titanium cathode connected to a voltage source is provided. For example, the mixed metal oxide and platinum, titanium electrodes each may specifically include a mixed metal oxide combination (two or more mixed metal oxides, namely, two or more of ruthenium oxide, iridium (IV) oxide, tantalum oxide, or those listed above and herein, or any combination thereof). In some aspects, reversed polarity is used to defoul/descale the electrode that was once the anode and is now the cathode (after the reversal of polarity), such that the system/process does not have to be shut down or bypassed. In some aspects, the electrodes are configured as a selectively replaceable cartridge that it is an easy replacement piece when the electrodes reach the end of their useful life.

Additional objects, advantages, and novel features of the invention will be set forth in part in the description which follows, and in part will become apparent to those skilled in the art upon examination of the following, or can be learned by practice of the invention.

### DESCRIPTION OF THE DRAWINGS

Aspects of the present disclosure can be better understood with reference to the following drawings. The components in the drawings are not necessarily to scale, with emphasis instead being placed upon clearly illustrating the principles of the disclosure. Aspects of the technology presented herein are described in detail below with reference to the accompanying drawing figures, wherein:

FIG. 1 is a schematic drawing of a simple bench scale test setup according to some embodiments described herein.

FIG. 2 is a schematic drawing of systems and methods described herein where the gaseous byproduct contains hydrogen gas, a halogen or halogen-containing gas, carbon dioxide gas, and a sulfur-containing gas.

FIG. 3 is a schematic drawing showing inputs and outputs of the three subsystems described herein.

FIG. 4 is a schematic representation of an embodiment of subsystem (2) as described herein showing the separation of hydrogen and utilization in an embodiment of subsystem (3), e.g., PEM fuel cells, to generate electricity.

FIG. 5A, FIG. 5B, and FIG. 5C include graphs showing GC analysis of gas samples collected during electro-oxidation (EO) according to some embodiments described herein.

FIG. 6A, FIG. 6B, and FIG. 6C include graphs showing showing GC analysis of gas samples collected during electro-oxidation (EO) according to some embodiments described herein.

FIG. 7A and FIG. 7B include graphs showing showing GC analysis of gas samples collected during electro-oxidation (EO) according to some embodiments described herein.

FIG. 8 is a hydrogen gas calibration chart

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

At a high level, embodiments of the present technology are directed towards processes, systems, and methods for treating contaminated waters, for instance, contaminated aqueous streams. For example, in some instances, a contaminated aqueous stream is a discharge water stream that is emitted from a produced water facility, sometimes referred to as a dirty water facility, or from industrial production or processing facilities, for example, from oil or gas wells or from systems associated with or related to oil or gas wells. In some instances, water produced in these processes or that are considered discharge water, for example water volumes or streams that are periodically or continuously discharged from these facilities (e.g. the ocean), may instead be pumped to in-land facilities, storage tanks or reservoirs, or to naturally occurring or natural substrate-based storage chambers or caverns.

In some aspects, embodiments of the technology described herein can provide multiple benefits compared to conventional systems, for instance, implementation of systems and/or processes described herein can be applied to contaminated waters like spent caustic-laden streams and per- and polyfluoroalkyl substance-laden streams and water-soluble organics (WSO)-laden streams. Spent caustic streams as used herein refer to, for example, sodium hydroxide waste streams derived from the “scrubbing” of sulfur-containing natural gas.

Moreover, in some aspects, embodiments of the technology described herein yield “green” and/or “blue” and/or “grey” hydrogen and allow for the production of like-type products using the hydrogen.

### Method

The method described herein may comprise, consist of, or consist essentially of the following steps: (1) a step of treating contaminated water, wherein a byproduct of said treating is a gaseous byproduct that comprises hydrogen and at least one other gas(es); and (2) a step wherein the at least one other gas(es) is/are removed from the gaseous byproduct, and a hydrogen-rich gaseous product is produced. In some embodiments, the method may further comprise, consist of, or consist essentially of an additional step (3). In this additional step (3), the hydrogen-rich gaseous product is used to produce electricity. In some embodiments, the hydrogen-rich gaseous product is used to produce electricity and the electricity is used to power the contaminated water treatment step (1). 2.5% to as high as 70% of the electricity needed for the contaminated water treatment step may be supplied by using the hydrogen-rich gaseous product to produce electricity.

### (1) Step 1

In a first step of the method, contaminated water is treated, and the treatment of the contaminated water produces a gaseous byproduct that contains hydrogen gas and at least one other gas.

The term “contaminated water” as used herein is not so limited. In some embodiments, the contaminated water may be a petroleum refining effluent (PRE). As understood by those in the art, petroleum refining effluent (PRE) is the waste water discharged from petroleum refineries. Petroleum refineries process raw crude oil into three categories of products: (1) fuel products, which include gasoline, distillate fuel oil, jet fuels, residual fuel oil, liquefied petroleum gases, refinery fuel, coke, and kerosene; (2) nonfuel products, which include asphalt and road oil, lubricants, naphtha solvents, waxes, nonfuel coke, and miscellaneous products, and (3) petrochemicals and petrochemical feedstocks including naphtha, ethane, propane, butane, propylene, butylene, and BTEX compounds (benzene, toluene, ethylbenzene, and xylene).

The term “contaminated water” may refer to water having one or more of the following components: hydrocarbons, phenols, ammonia, sulfides, organic and/or inorganic salts, PFAS, or any combination thereof. The amount of water in the contaminated water may vary from 50% to 95%, from 50% to 90%, from 50% to 85%, from 50% to 80%, from 50% to 75%, from 50% to 70%, from 50% to 65%, from 50% to 60%, or from 50% to 55%. The amount of hydrocarbons in the contaminated water may range from 0.005% to 15%, from 0.005% to 14%, from 0.005% to 13%, from 0.005% to 12%, from 0.005% to 11%, from 0.005% to 10%, from 0.005% to 9%, from 0.005% to 8%, from 0.005% to 7%, from 0.005% to 6%, from 0.005% to 5%, from 0.005% to 4%, from 0.005% to 3%, from 0.005% to 2%, from 0.005% to 1%, or from 0.01% to 10%. Amounts of ammonia may vary from 0.005% to 5%, from 0.005% to 4%, from 0.005% to 3%, from 0.005% to 2%, from 0.005% to 1%, or from 0.01% to 1%. Amounts of organic and/or inorganic salts may vary from 1% to 35%, from 1% to 30%, from 1% to 25%, from 1% to 20%, from 1% to 15%, from 1% to 10%, from 1% to 5%, or from 5% to 25%. Amounts of sulfides may range from 0.05% to 10%, from 0.05% to 9%, from 0.05% to 8%, from 0.05% to 7%, from 0.05% to 6%, from 0.05% to 5%, from 0.05% to 4%, from 0.05% to 3%, from 0.05% to 2%, from 0.05% to 1%, or from 0.1% to 6%. Per- and polyfluoroalkyl substances (PFAS) may be present in amounts ranging from 1 to 10,000 parts per trillion, from 1 to 10,000 parts per trillion, from 1 to 9,000 parts per trillion, from 1 to 8,000 parts per trillion, from 1 to 7,000 parts per trillion, from 1 to 6,000 parts per trillion, from 1 to 5,000 parts per trillion, from 1 to 4,000 parts per trillion, from 1 to 3,000 parts per trillion, from 1 to 2,000 parts per trillion, from 1 to 1,000 parts per trillion, from 1 to 750 parts per trillion, from 1 to 500 parts per trillion, from to 1 250 parts per trillion, from 1 to 100 parts per trillion, or from 1 to 50 parts per trillion. The sum of all components in the contaminated water, including the amount of water, totals 100%.

In some embodiments, the contaminated water preferably has a salt content of about 2,000±500 ppm to 300,000±500 ppm or from about 2,500±500 ppm to 250,000±500 ppm or. Salt content changes the resistivity/conductivity of the contaminated water. In one aspect, the system can tolerate salt contents as low as from about 25.0 ppm to about 2,000.0±500 ppm.

The term “treating” is also not so limited. Treating contaminated water, in some instances, may comprise, consist of, or consist essentially of removing one or more of the components mentioned in the preceding paragraph from the contaminated water. For example, treating may comprise, consist of, or consist essentially of partially, substantially, or completely removing hydrocarbons, phenols, ammonia, sulfides, organic and/or inorganic salts, PFAS, or any combination of the foregoing from the contaminated water.

In some instances, treating contaminated water may comprise, consist of, or consist essentially of the addition of components to the contaminated water. For example, components may be added to customize and/or enhance the generation of hydrogen and/or other byproducts of value. For example, addition of components that increase the hydroxyl radical concentration of the contaminated water may be added. In other embodiments, demulsifiers may be added to the contaminated water to separate the organics. In other embodiments, coagulants (e.g., aluminum or iron salts such as aluminum sulfate, ferric chloride, or the like) may be added to the contaminated water.

In some embodiments, treating the contaminated water may comprise, consist of, or consist essentially of removing water-soluble organics (WSOs) or water-soluble organic compounds (WSOCs) from the contaminated water. All hydrocarbons will partition to some extent to the water phase, i.e., they will dissolve to at least some extent in the water. Some species, including aromatics such as benzene, toluene, ethylbenzene, and xylene, partition or become dissolved in the water in measurable quantities. Polar hydrocarbons, e.g., carboxylic acids (fatty acids) may be soluble in water at higher pH, but not at lower pH.

In some embodiments, treating contaminated water to remove water-soluble organics (WSOs) or water-soluble organic compounds (WSOCs) from the contaminated water comprises, consists of, or consists essentially of an electro-oxidation process. Electro-oxidation is a process of treating contaminated water by employing an oxidative reaction at the electrode surface to break down and remove organic and inorganic pollutants present in water. Electric current is applied to water which leads to the formation of oxidative species like hydroxyl radicals. Using the oxidizing agents, the inorganic and organic pollutants present in water are oxidized and in turn the water is purified of these impurities. During the process of Electro-oxidation, hydrogen gas is produced along with other gases like carbon dioxide gas, oxygen gas, and chlorine gas depending on the pollutants in the contaminated water.

The electro-oxidation process utilizes an electro-oxidation (EO) unit. The EO unit may comprise, consist of, or consist essentially of the following parts: inlet(s) that allow contaminated water to enter the EO unit, outlet(s) that allow treated water to exit the EO unit, a power supply, one or more pairs (i.e., one anode and one cathode), of electrodes, and a tank to hold the contaminated water while it is being treated. In some embodiments, the EO unit comprises one or more electrode pairs (i.e., an anode and a cathode) where the anode and the cathode are both made of titanium. In some embodiments, one or more of the electrode pairs may comprise an anode coated with a mixed metal oxide, including typically for example ruthenium oxide (RuO2), iridium oxide (IrO2), or platinum oxide (PtO2). Mixed metal oxide electrodes, also called dimensionally stable anodes, are devices with high conductivity and corrosion resistance for use as electrodes (specifically, anodes) in electrolysis. They are typically made by coating a substrate, such as a pure titanium plate or expanded mesh, with one or several kinds of metal oxides such as ruthenium oxide (RuO2), iridium (IV) oxide (IrO2), or platinum oxide (PtO2), which conducts electricity and catalyzes the reaction. Oxides containing two or more different kinds of metal cations are known as mixed metal oxides. Oxides can be binary, ternary and quaternary and so on with respect to the presence of the number of different metal cations. They can be further classified based on whether they are crystalline or amorphous. If the oxides are crystalline, then the crystal structure can determine the oxide composition. For instance, perovskites have the general formula ABO3; scheelites, ABO4; spinels, AB204; and palmeirites, A3B208. The different metal cations (MI and MII) are present as MIn+-Ox and MIIn+-Ox polyhedra, which are connected in various possible ways, such as corner or edge sharing, forming chains MI-O-MII-O, MI-O-MI-O or MII-O-MII-O. Therefore, MMO coatings typically consist of an electro-catalytic conductive component that catalyzes the reaction to generate current flow, and bulk oxides (cheaper fill materials) that prevent corrosion of the substrate material (titanium). For cathodic protection applications, one primary electro catalysts that can be used is ruthenium oxide. Other oxides are a mixture of titanium dioxide (TiO2) and tantalum oxide (TaO5). Titanium dioxide and/or tantalum oxide can further provide an oxide film over the substrate material (e.g., the titanium) to prevent corrosion of the substrate.

In some embodiments, the polarity of the electrodes in the electrode pair (i.e., an anode and a cathode) may be reversed, i.e., the anode becomes the cathode and the cathode becomes the anode. Reversal of polarity may be used to defoul/descale the electrode that was once the anode and is now the cathode (after the reversal of polarity), such that the system/process does not have to be shut down or bypassed. In some aspects, the electrodes are configured as a selectively replaceable cartridge that it is an easy replacement piece when the electrodes reach the end of their useful life. As such, the system/process is consistent in producing efficient and effective results (e.g., acceptable discharge water) even during maintenance and upkeep. Moreover, the system/process has a reduced size and footprint, a reduced weight, and a reduced capital expenditure and operating cost.

Voltage used in the electro-oxidation process is not so limited, and may range from about 0.5V to about 20V, from about 1V to about 20V, from about 1V to about 19V, from about 1V to about 18V, from about 1V to about 17V, from about 1V to about 16V, from about 1V to about 15V, from about 1V to about 14V, from about 1V to about 13V, from about 1V to about 12V, from about 1V to about 11V, from about 1V to about 10V, from about 1V to about 9V, from about 1V to about 8V, from about 1V to about 7V, from about 1V to about 6V, from about 1V to about 5V, rom about 1V to about 4V, from about 1V to about 3V, or from about 1V to about 2V.

More importantly, the current density of the electro-oxidation process is preferably about 10 to 70 milliamps per square centimeter (mA/cm²), most preferably in a ranged from about 20 to 60 mA/cm², from about 30 to 60 mA/cm², from about 40 to 60 mA/cm², or from about 50 to 60 mA/cm². Depending on the salt content of the contaminated water, the voltage may need to be adjusted to achieve the desired current density. Contaminated water with lower salt content (i.e., contaminated water that is more resistive and less conductive) will require a higher voltage to achieve the desired current density. Contaminated water with higher salt content (i.e., contaminated water that is less resistive and more conductive) will require a lower voltage to achieve the desired current density. Without wishing to be bound by any particular theory, a minimum salt content of 2,500 ppm may be desired so that current density remains between about 20 to 60 mA/cm² when a voltage between 1-4 V is applied. In some embodiments, current densities from 25 to 60 mA/cm² are achieved using voltages less than 4V, e.g., about 3.8 V.

In some embodiments, contaminated water entering the electro-oxidation unit may be monitored for its level of contamination, and voltage, current density, etc. may be adjusted to create a gaseous byproduct with more or less hydrogen gas, as desired.

In embodiments, treating the water produces a gaseous byproduct that comprises, consists of, or consists essentially of hydrogen and at least one other gas. The at least one other gas is selected from the following: halogen gas (e.g., chlorine gas, fluorine gas, iodine gas, and bromine gas), oxygen gas, carbon dioxide gas, sulfur-containing gas (e.g., hydrogen sulfide (H₂S), sulfur dioxide (SO₂)), or any combinations thereof. For example, the gaseous byproduct may comprise, consist of, or consist essentially of hydrogen gas and a halogen gas or halogen-containing gas, e.g., chlorine gas. In some embodiments, the gaseous byproduct may comprise, consist of, or consist essentially of hydrogen gas, a halogen gas or halogen-containing gas, e.g., chlorine gas, and a sulfur-containing gas, e.g., hydrogen sulfide. In some embodiments, the gaseous byproduct may comprise, consist of, or consist essentially of hydrogen gas, carbon dioxide, a halogen gas or halogen-containing, e.g., chlorine gas, and a sulfide-containing gas, e.g., hydrogen sulfide. In some embodiments, the gaseous byproduct may comprise, consist of, or consist essentially of hydrogen gas, carbon dioxide, oxygen gas, a halogen gas or halogen-containing gas, e.g., chlorine gas, and a sulfide-containing gas, e.g., hydrogen sulfide.

Collection of the gaseous byproduct in this step is important, and may be done by any acceptable means currently known or to be devised in the future. In an electro-oxidation process, gas may be collected on a cathode side.

Transportation of the collected gaseous byproduct is also important, and may be done by any acceptable means currently known or to be devised in the future. The collected gaseous byproduct needs to be transported to device(s)/subsystem(s)/system(s) where the at least one other gases are removed to eventually form the hydrogen-rich gaseous product.

### (2) Step 2

In a second step of the method, gases other than hydrogen may be removed from the gaseous byproduct. This may be done by removing one or more of the non-hydrogen gases at a time. This may be done until mainly hydrogen gas remains, i.e., until the hydrogen-rich gaseous product remains. The hydrogen-rich gaseous product is preferably at least 90% hydrogen, more preferably at least 95% hydrogen, even more preferably more than 98% hydrogen, and most preferably more than 99% hydrogen. Ultra-pure hydrogen, e.g., 99.99%, is typically desired for use in fuel cells.

In embodiments, where the gaseous byproduct comprises, consists of, or consists essentially of hydrogen and a halogen gas (i.e., chlorine gas, bromine gas, iodine gas, fluorine gas, or any combination thereof) or halogen-containing gas (e.g., HF, ClF₃, SiF₃, BrF₃, BrF₅, WF₆, TiF₄, BF₃, MoF₆, HCl, or any combination thereof), the halogen or halogen-containing gas may be partially or completely removed from the gaseous byproduct by any acceptable means currently known or to be devised in the future.

In some embodiments, removing the halogen or halogen-containing gas from the gaseous byproduct may involve the use of lime (CaO), soda lime (CaO and NaOH), activated alumina, or a mixture of calcium hydroxide and potassium hydroxide. When lime (CaO) is used, the resulting bleach salt byproducts, e.g., CaOCl, CaOBr, etc., are commercially desirable.

In embodiments where the gaseous byproduct comprises, consists of, or consists essentially of hydrogen and carbon dioxide gas, the carbon dioxide gas may be partially or completely removed by any acceptable means currently known or to be devised in the future.

In some embodiments, an amine-containing material may be used to remove carbon dioxide. In some embodiments, the amine-containing material may be a monoethanolamine solution (20-30 wt. % in water) typically used in amine scrubbing, which allows for CO₂ collection with high purity (often >99%). Carbonate salts, e.g., sodium bicarbonate, result from amine scrubbing processes.

Other examples of amine-containing materials that may be used are amine-functionalized materials, e.g., amine-functionalized porous support materials. Examples of amine-functionalized porous support materials include, but are not limited to, amine-functionalized mesoporous silica, amine-functionalized fumed silica, amine-functionalized zeolite, amine-functionalized protonated titanate nanotubes (PTNTs), amine-functionalized nanoporous titanium oxyhydrate, amine-functionalized carbon nanotubes (CNTs), amine-functionalized PMMA, amine-functionalized silica gel, amine-functionalized PAN carbon fibers, amine-functionalized nanosilica, amine-functionalized TiO₂, and the like. The porous support materials may be “functionalized” by wet impregnation or anchoring on the surface with covalent bonds. Amines used for functionalization of these porous support materials include tetraethylenepentamine (TEPA), triethylenetetramine (TETA), pentaethylenehexamine (PEHA), Polyethylenimine (PEI), ethylenepentamine (EPA), monoethanolamine, branched polyethylenimine (BPEI), diethylenetriamine (DETA), and linear polyethylenimine (LPEI).

In embodiments where the gaseous byproduct comprises, consists of, or consists essentially of hydrogen gas and a sulfur-containing gas, the sulfur-containing gas may be partially or completely removed by any acceptable means currently known or to be devised in the future. Sulfur-containing gas comprises, consist of, or consists essentially of one or more selected from: hydrogen sulfide (H₂S), sulfur dioxide (SO₂), dimethyl sulfide, methane thiol, dimethyl disulfide, and any combination thereof.

In some embodiments the sulfur-containing gas may be partially or completely removed from the gaseous byproduct using a caustic material. In some embodiments, the caustic material may be a caustic solution. For example, a caustic solution comprising NaOH, KOH, LiOH, ammonium hydroxide, and the like. Using a caustic solution of ammonium hydroxide and water will result in the formation of ammonium sulfate, which is commonly used as a soil fertilizer.

The removal of the gases other than hydrogen from the gaseous byproduct may be done in any order so long as the hydrogen-rich gaseous product may eventually be obtained. For example, for a gaseous byproduct comprising, consisting of, or consisting essentially of hydrogen, carbon dioxide, a halogen gas or halogen-containing gas, and a sulfur-containing gas the gases other than hydrogen may be removed in the following order: first remove halogen gas or halogen-containing gas, then remove carbon dioxide, and finally remove sulfur-containing gas.

### (3) Step 3

In some embodiments, the method may further comprise, consist of, or consist essentially of a third step (3) in which the hydrogen-rich gaseous product from step (2) is used as fuel for a device capable of producing electricity from the hydrogen-rich gaseous product. For example, the hydrogen-rich gaseous product may be used as fuel for a hydrogen fuel cell. In some embodiments, the hydrogen-rich gaseous product may be used as fuel for a hydrogen fuel cell, and electricity may be produced. In some embodiments, this electricity may be used to power the water treatment of step (1) of this method. In such embodiments, from about 2.5% to as high as 70%, from about 20% to as high as about 70%, from about 20% to about 60%, from about 20% to about 50%, from about 20% to about 40%, from about 20% to about 30%, of the energy needed in the water treatment step may be provided using electricity produced from the hydrogen-rich gaseous product.

### System

In one aspect, a system is described that comprises, consists of, or consists essentially of the following subsystems: (1) a subsystem configured for, capable of, and/or adapted to treat contaminated water, wherein a gaseous byproduct comprising hydrogen and at least one other gas is produced by treating the contaminated water; and (2) a subsystem configured for, capable of, and/or adapted to remove the at least one other gas from the gaseous byproduct to produce a hydrogen-rich gaseous product. In some embodiments, the system may further comprise, consist of, or consist essentially of a subsystem (3) that is configured for, capable of, and/or adapted to use the hydrogen-rich gaseous product to produce electricity. In some embodiments, the system may be configured for, capable of, and/or adapted to use the produced electricity from subsystem (3) to power the treatment of the contaminated water in subsystem (1). The hydrogen-rich gaseous product may be used to produce 2.5% to 70% or as high as 20-70% of the electricity needed to power the treatment of the contaminated water in subsystem (1).

### (1) Subsystem 1—

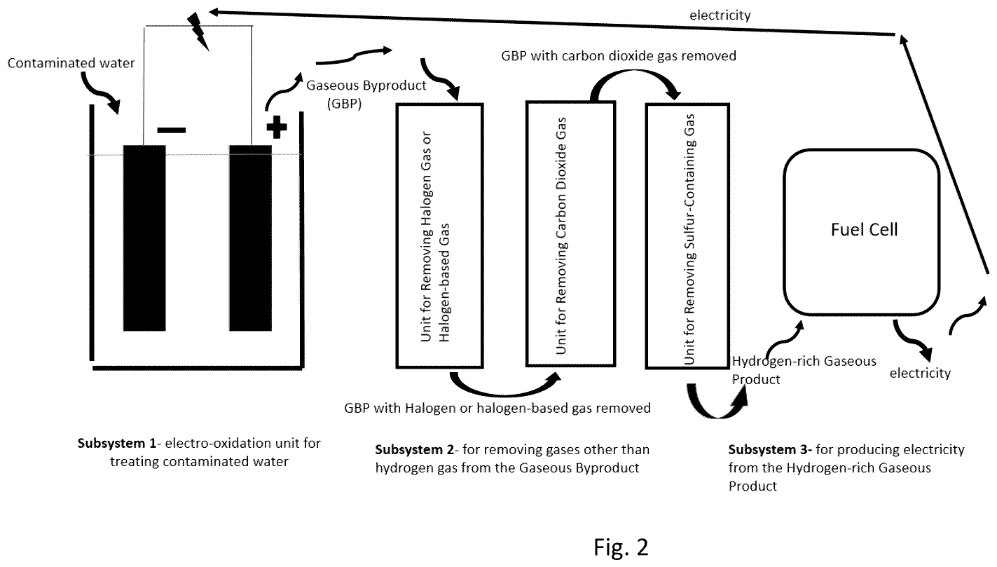

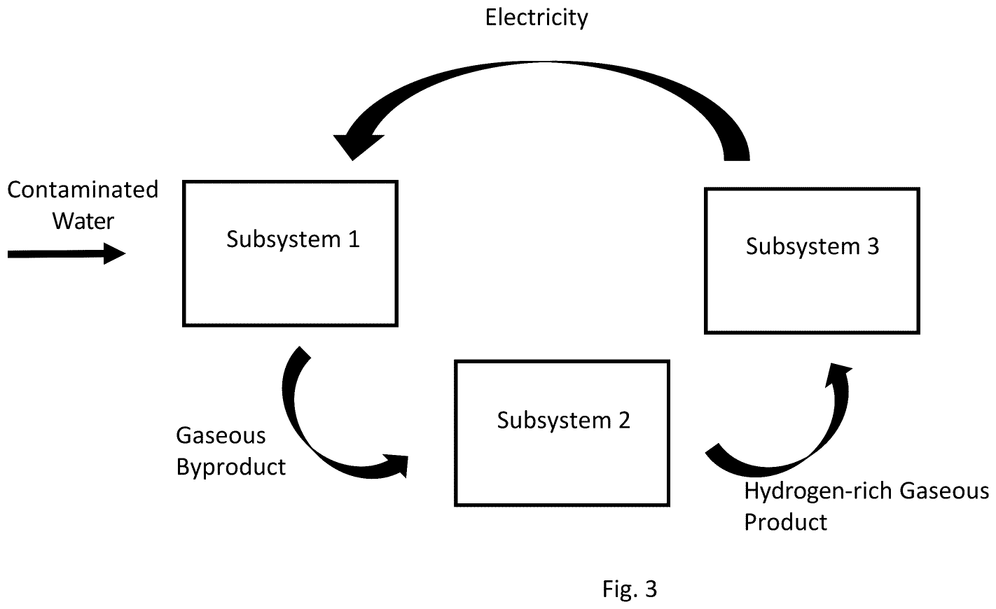

The subsystem for treating contaminated water is not so limited. Any system for treating contaminated water that generates a gaseous by product as described herein (e.g., a gaseous by product comprising, consisting of, or consisting essentially of hydrogen gas and at least one other gas) may be subsystem 1 as described herein. See also FIG. 2 and FIG. 3.

In some embodiments, subsystem 1 may comprise, consist of, or consist essentially of an EO cell or EO unit as described herein. A schematic drawing of an EO unit is shown in FIG. 2.

For example, the EO unit may comprise, consist of, or consist essentially of the following parts: inlet(s) that allow contaminated water to enter the EO unit, outlet(s) that allow treated water to exit the EO unit, a power supply, one or more pairs (i.e., one anode and one cathode), of electrodes, and a tank to hold the contaminated water while it is being treated. In some embodiments, the EO unit comprises one or more electrode pairs (i.e., an anode and a cathode) where the anode and the cathode are both made of titanium. In some embodiments, one or more of the electrode pairs may comprise an anode coated with a mixed metal oxide, including typically for example ruthenium oxide (RuO₂), iridium oxide (IrO₂), or platinum oxide (PtO₂). Mixed metal oxide electrodes, also called dimensionally stable anodes, are devices with high conductivity and corrosion resistance for use as electrodes (specifically, anodes) in electrolysis. They are typically made by coating a substrate, such as a pure titanium plate or expanded mesh, with one or several kinds of metal oxides such as ruthenium oxide (RuO2), iridium (IV) oxide (IrO2), or platinum oxide (PtO2), which conducts electricity and catalyzes the reaction. Oxides containing two or more different kinds of metal cations are known as mixed metal oxides. Oxides can be binary, ternary and quaternary and so on with respect to the presence of the number of different metal cations. They can be further classified based on whether they are crystalline or amorphous. If the oxides are crystalline, then the crystal structure can determine the oxide composition. For instance, perovskites have the general formula ABO3; scheelites, ABO4; spinels, AB2O4; and palmeirites, A3B2O8. The different metal cations (MI and MII) are present as MIn+-Ox and MIIn+-Ox polyhedra, which are connected in various possible ways, such as corner or edge sharing, forming chains MI-O-MII-O, MI-O-MI-O or MII-O-MII-O. Therefore, MMO coatings typically consist of an electro-catalytic conductive component that catalyzes the reaction to generate current flow, and bulk oxides (cheaper fill materials) that prevent corrosion of the substrate material (titanium). For cathodic protection applications, one primary electro catalysts that can be used is ruthenium oxide. Other oxides are a mixture of titanium dioxide (TiO2) and tantalum oxide (TaO5). Titanium dioxide and/or tantalum oxide can further provide an oxide film over the substrate material (e.g., the titanium) to prevent corrosion of the substrate.

An input to subsystem (1) may comprise, consist of, or consist essentially of contaminated water as described herein. See FIG. 3. Output of subsystem (1) may comprise, consist of, or consist essentially of a gaseous byproduct as described herein. See FIG. 3.

In some embodiments, subsystem (1) may further comprise sensors, e.g., sensors placed at the inlet(s), to monitor the level of contamination of the water. The system may further be configured for, capable of, and/or adapted to adjust the applied voltage, the current density, etc. in response to the measured level of contamination to generate a gaseous byproduct with a larger or smaller percentage of hydrogen gas.

### (2) Subsystem 2—

Subsystem (2) may comprise, consist of, or consist essentially of one or more units for removing gases other than hydrogen from the gaseous byproduct. The input of subsystem (2) comprises, consists of, or consists essentially of the gaseous byproduct from subsystem (1). See FIG. 2 and FIG. 3. In some embodiments, the units may be wet gas scrubber units that use liquid solutions to remove one or more gases other than hydrogen from the gaseous byproduct. In other embodiments, they may dry gas scrubber units that use solid sorbents to remove one or more gases other than hydrogen from the gaseous byproduct.

In some embodiments, subsystem (2) may comprise, consist of, or consist essentially of a unit for removing halogen gas or halogen-containing gas from the gaseous byproduct. The unit for removing halogen or halogen-containing gas from the gaseous byproduct may utilize lime (CaO), soda lime (CaO and NaOH), activated alumina, or a mixture of calcium hydroxide and potassium hydroxide for this purpose. A unit utilizing a lime solution for this purpose would be a wet scrubber unit.

In some embodiments, subsystem (2) may comprise, consist of, or consist essentially of a unit for removing carbon dioxide gas from the gaseous byproduct.

In some embodiments, the unit may utilize an amine-containing material to remove carbon dioxide gas from the gaseous product. The amine-containing material may be a monoethanolamine solution (20-30 wt. % in water) typically used in amine scrubbing, which allows for CO₂ collection with high purity (often >99%). Carbonate salts, e.g., sodium bicarbonate, result from amine scrubbing processes. In such embodiments, the unit may be a wet scrubber unit.

Other examples of amine-containing materials that may be used are amine-functionalized materials, e.g., amine-functionalized porous support materials. Examples of amine-functionalized porous support materials include, but are not limited to, amine-functionalized mesoporous silica, amine-functionalized fumed silica, amine-functionalized zeolite, amine-functionalized protonated titanate nanotubes (PTNTs), amine-functionalized nanoporous titanium oxyhydrate, amine-functionalized carbon nanotubes (CNTs), amine-functionalized PMMA, amine-functionalized silica gel, amine-functionalized PAN carbon fibers, amine-functionalized nanosilica, amine-functionalized TiO₂, and the like. The porous support materials may be “functionalized” by wet impregnation or anchoring on the surface with covalent bonds. Amines used for functionalization of these porous support materials include tetraethylenepentamine (TEPA), triethylenetetramine (TETA), pentaethylenehexamine (PEHA), Polyethylenimine (PEI), ethylenepentamine (EPA), monoethanolamine, branched polyethylenimine (BPEI), diethylenetriamine (DETA), and linear polyethylenimine (LPEI). In such embodiments, the unit may be a dry scrubber unit that uses solid sorbents.

In some embodiments, subsystem (2) may comprise, consist of, or consist essentially of a unit for removing sulfur-containing gas from the gaseous byproduct.

In some embodiments, a caustic material may be used to partially or completely remove a sulfur-containing gas from the gaseous byproduct using a caustic material. In some embodiments, the caustic material may be a caustic solution. For example, a caustic solution comprising NaOH, KOH, LiOH, ammonium hydroxide, and the like. In embodiments where a caustic solution is used, the unit may be a wet scrubber unit.

Subsystem (2) may include other units for removing gases other than hydrogen from the gaseous byproduct. Units may include more wet or dry scrubbing units, units utilizing gas separation membranes, and the like. Units may utilize different gas separation techniques including, but not limited to pressure swing absorption techniques, vacuum swing absorption techniques, temperature swing absorption techniques, and the like.

The order or arrangement of the units in subsystem (2) is not so limited. In some embodiments, the units may be provided in the following order: unit for removing halogen gas or halogen-containing gas, and then unit for removing carbon dioxide; unit for removing halogen gas or halogen-containing gas, and then unit for removing carbon dioxide, and finally unit for removing sulfur-containing gas; unit for removing carbon dioxide, and then unit for removing halogen gas or halogen-containing gas; unit for removing carbon dioxide, and then unit for removing halogen or halogen-containing gas, and finally unit for removing sulfur-containing gas; unit for removing sulfur-containing gas, and then unit for removing carbon dioxide; unit for removing sulfur-containing gas, and then unit for removing halogen gas or halogen-containing gas; unit for removing sulfur-containing gas, and then unit for removing carbon dioxide, and finally unit for removing halogen gas or halogen-containing gas; or unit for removing sulfur-containing gas, and then unit for removing halogen gas or halogen-containing gas, and finally unit for removing carbon dioxide.

In addition, subsystem (2) may further comprise, consist of, or consist essentially of units for removing solid particles and/or liquid droplets from the gaseous byproduct. For example, in some embodiments, the units for removing solid particles and/or liquid droplets may be an electrostatic precipitator or some other unit that accomplishes the same or similar function.

The output of subsystem (2) may comprise, consist of, or consist essentially of a hydrogen-rich gaseous product. See FIG. 3. In some embodiments, the hydrogen-rich gaseous product is suitable for use a fuel for a device such as a hydrogen fuel cell.

### (3) Subsystem 3—

Subsystem (3) comprises, consists of, or consists essentially of a device for converting the hydrogen-rich gaseous product into electricity. The input for subsystem (3) may comprise, consist of, or consist essentially of the hydrogen-rich product from subsystem (2). In some embodiments, the device is a hydrogen fuel cell. In such embodiments, the input for subsystem (3) may comprise, consist of, or consist essentially of the hydrogen-rich product from subsystem (2) and oxygen gas.

The hydrogen fuel cell may comprise, consist of, or consist essentially of at least the following components, an anode, a cathode, and an electrolyte membrane. In a fuel cell, hydrogen and oxygen are combined to generate electricity, heat, and water.

The output of subsystem (3) may comprise, consist of, or consist essentially of electricity. See FIG. 3. In some embodiments, this electricity may be used to power subsystem (1). Subsystem (3) may provide from about 2.5% to about 70%, from about 20% to 70% from about 20% to about 60%, from about 20% to about 50%, from about 20% to about 40%, or from about 20% to about 30%, of the electricity needed to power subsystem (1).

Embodiments described herein can be understood more readily by reference to the embodiments and examples described above. Elements, apparatus, and methods described herein, however, are not limited to any specific embodiment presented in the Examples. It should be recognized that these are merely illustrative of some principles of this disclosure, and are non-limiting. Numerous modifications and adaptations will be readily apparent without departing from the spirit and scope of the disclosure.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

Further disclosure regarding systems and methods can be found in U.S. patent application Ser. No. 18/648,127, titled Systems and Methods for Separating and/or Removing Water Soluble Organics from Aqueous Streams, which was filed on Apr. 26, 2024, is incorporated by reference herein in its entirety.

### EXAMPLES

### Goal of the Test:

To quantify purity and amount of hydrogen generated at various test parameters.

To utilize the hydrogen generated as feed to PEFMCs (Proton Exchange Membrane Fuel Cells) for quantification of electricity generated at various test parameters.

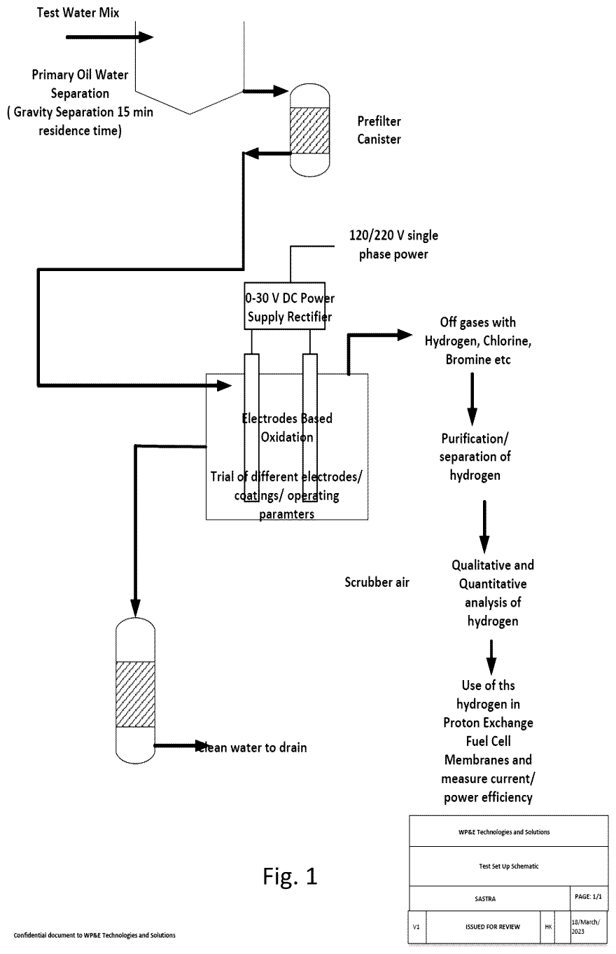

A simple bench scale test setup is shown in FIG. 1.

### The Test Setup Comprises:

Conducted as a batch process on a bench scale.

The test water formulations contain the below chemicals/organics at various concentrations:
85-99% Water
Diesel
Petrol
Tar/Bitumen
Soap as a surfactant
Sodium Chloride
Sodium Carbonate

1-gallon plastic tank with a removable lid on top and ½″ outlet plastic tubing connector at the bottom of the tank with a valve. This is the feed tank. The test water mixed with the organics is poured into the feed tank. A stirrer on the tank mixes the water well so a strong emulsion is made. Stirring is to be done for 2-4 hr. until the feed tank is a uniform water solution.

The contents in the feed tank are let to sit for 1 hr. Then contents of the tank are poured by gravity into a filter cartridge canister.

The outlet ½″ port of the filter canister pours by gravity to the Test Electro-Oxidation Cell (EO Cell)

The foregoing steps are the sample preparation stage. The TDS Content shall be in the range of 3%-10%. TOC content in the range of 0.5-5%. The TOC/TDS of the feed stream to the EO cell was analyzed and may be checked monthly. Evaluation of the performance of the Electro-oxidation cells conducted at various ranges of TDS in the Feed.

On the EO cell, the anode and cathode plates are provided and will have specific coatings and metallurgy. The anode and cathode are connected to a DC power supply through a 0-30 VDC (0-30 amps) rectifier power supply. The cell(s) are immersed (1-2-gallon capacity in that the effective working volume for the cells to be completely immersed). It has an ½″ Inlet Nozzle, ½″ Outlet nozzle at the bottom, and an air-tight lid (that can open and close) so the cell can be cleaned after each test. The cell has a 4″ vent with a valve for the off-gas. This off-gas during the test contains hydrogen, chlorine, and CO₂, which are byproducts of electro-oxidation. These gases are mostly generated at the cathode side.

The off-gases are at atmospheric pressure. Hydrogen is separated and purified from these off-gases. The separated hydrogen and purity is quantified.

Hydrogen separation is done using a silver palladium membrane or through pressure swing absorption.

The separated hydrogen is feed to a Proton Exchange Fuel Cell Membrane. The other feed can be air (oxygen). The byproduct water is reused or drained

The current generated and efficiency are quantified.

The clean treated water from the EO cell is filtered through a carbon filter canister and

drained.

Test parameters as established:
TDS/Conductivity of water
Current generated/voltage applied on EO cells
Quantity of off-gas
H2 content in off-gas
H2 content after purification
Other monitoring parameters on PEFM fuel cell including current and voltage generated.
Quantification of electricity and efficiency

### Test

Phase I. Perform electro-oxidation of effluent and quantify purity and amount of hydrogen generated at various test parameters.
Phase II. To utilize the hydrogen generated as feed to PEFMCs (Proton Exchange Membrane Fuel Cells) for quantification of electricity generated at various test parameters.

### Phase I Details

A simple bench scale test setup is fabricated. The test water contains 85-99% Water, and traces of diesel, Petrol, Tar/Bitumen, Soap as Surfactant, Sodium Chloride and Sodium Carbonate.

The feed is passed through filter cartridge canister and the filtered waters flows to the Test Electro-Oxidation Cell (EO Cell) by gravity.

Evaluation of performance of the Electro-oxidation cells is done at various ranges of TDS in the Feed. The TDS Content are in the range of 3%-10%. TOC content in the range of 0.5-5%. TOC/TDS of the feed stream are monitored regularly for the test.

On the EO cell, the anode and cathode plates will have specific coatings and metallurgy. The anode and cathode are connected to a DC power supply through a 0-30 VDC (0-30 amps) rectifier power supply. The gas is collected from the cathode side.

Off-gas during the test is collected and tested.

The clean treated water from the EO cell is filtered through a carbon filter canister and drained.

### Test Parameters:

TDS/conductivity of water
TOC of water
Current generated/Voltage applied on EO cells
Quantity of off-gas
H₂ content in off-gas (GC)

### Phase II Details

After completing Phase, I and assessing the hydrogen recovery potential, Phase II commenced as follows:

The hydrogen is separated and purified from the off-gases. Hydrogen separation is done using either silver palladium membrane or through pressure swing absorption.

Exchange Fuel Cell Membrane. The other feed can be air (oxygen). The byproduct water can be reused or drained.

The current generated and efficiency are quantified.

### Test Parameters:

TDS/Conductivity of water
Current generated/voltage applied on EO cells
TDS/conductivity of water
Current generated/voltage applied on EO cells
Quantity of off-gas
H₂ content in off-gas
H₂ content after purification
Other monitoring parameters on PEFM cell including current and voltage generated.
Quantification of Electricity and efficiency.

Therefore, the following is claimed: 1. A system for hydrogen as described herein; 2.

A method for hydrogen, as described herein; 3. A device for hydrogen as described herein; 4. A method of using a system or device for hydrogen as described herein; 5. A method of using hydrogen from a system or device for hydrogen as described herein.

### Phase IA—Introduction

Electro-oxidation is a process of treating wastewater by employing an oxidative reaction at the electrode surface to break down and remove organic and inorganic pollutants present in water. Electric current is applied to water which leads to the formation of oxidative species like hydroxyl radicals. Using the oxidizing agents, the inorganic and organic pollutants present in water are oxidized and in turn the water is purified of these impurities. During the process of Electro-oxidation, hydrogen gas is produced including other gases like carbon dioxide gas, oxygen gas, and chlorine gas depending on the pollutants in the waste water. The hydrogen produced during the treatment of wastewater can be collected, purified, and used for energy production with the help of fuel cells. Thus, the objectives are to assess the rate of hydrogen evolution during the electro-oxidation treatment of industrial waste water and use them in the fuel cell to produce electricity. In the phase IA hydrogen released from the electro-oxidation process is quantified. In the phase IIA, the purification and conversion of hydrogen into electricity are examined.

### Phase IA Objective

To quantify the amount of hydrogen produced and purity at various test parameters.

### Phase IA Experimental Plan

An Electro-oxidation (EO) cell or EO unit is constructed (MOC: borosilicate glass) with due consideration to the safety. Electrodes and a rectifier were provided to supply power. The controllers in the rectifier have provisions to adjust the voltage and current. 1.2 L of the sample was filled in the EO cell or EO unit, and required voltage was applied to generate the hydrogen.

Simulated wastewater samples having compositions as shown in Table 1 were prepared and used in the analysis:

TABLE 1
Sample Composition

| | Sample 1 | Sample 2 |
|---|---|---|
| Chemical | % composition (mass %) | % composition (mass %) |
| NaCl | 3.5 | 3.5 |
| Na₂CO₃ | 2.0 | 2.0 |
| Na₂SO₄ | 2.5 | 2.5 |
| CaSO₄ | 1.5 | 1.5 |
| Gasoline | | 0.1 |
| Diesel | | 0.05 |
| Water | 90.5 | 90.35 |

The gas produced from the EO process is collected in a Tedlar® bag and the sample for GC analysis was taken in serum bottles. The amount of hydrogen present in the sample was obtained from GC analysis using a calibration chart prepared earlier with known concentration H₂ samples.

Initial experiments were conducted at different conditions (V & I) as indicated in Table 2 below to assess has production rate.

TABLE 2
Experimental conditions

| | | | | Gas flow rate |
|---|---|---|---|---|
| Run number 1 | Voltage (V) | Current (A) | Sample | (Nm³/h) |
| 1 | 3.68 | 40 | 1 | 0.0085 |
| 2 | 3.8 | 50 | 1 | 0.0111 |
| 3 | 4 | 60 | 1 | 0.0133 |
| 4 | 3.68 | 40 | 2 | 0.0117 |
| 5 | 3.8 | 50 | 2 | 0.0160 |
| 6 | 4 | 60 | 2 | 0.0191 |

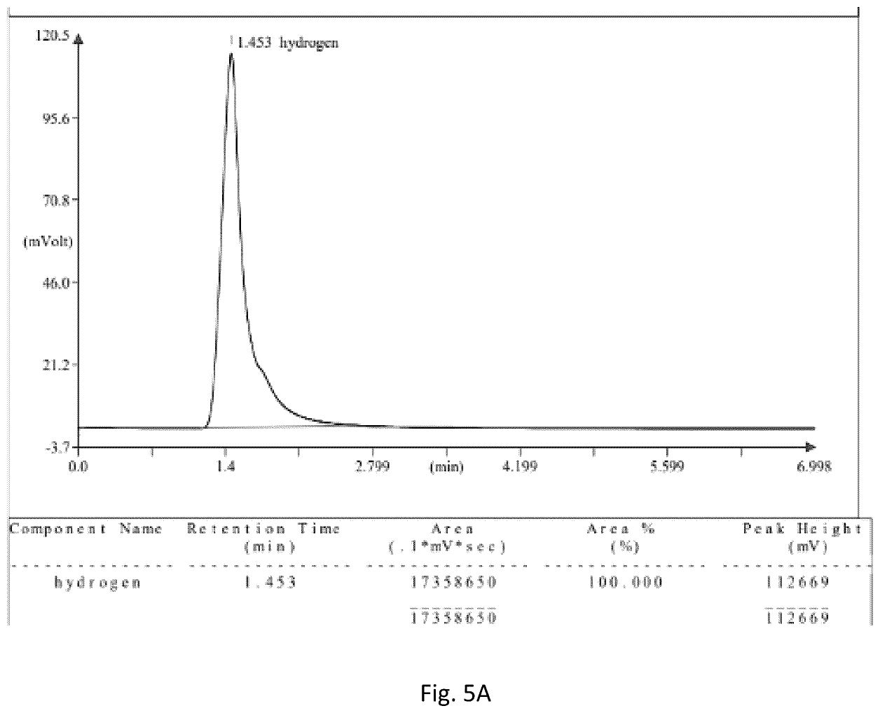

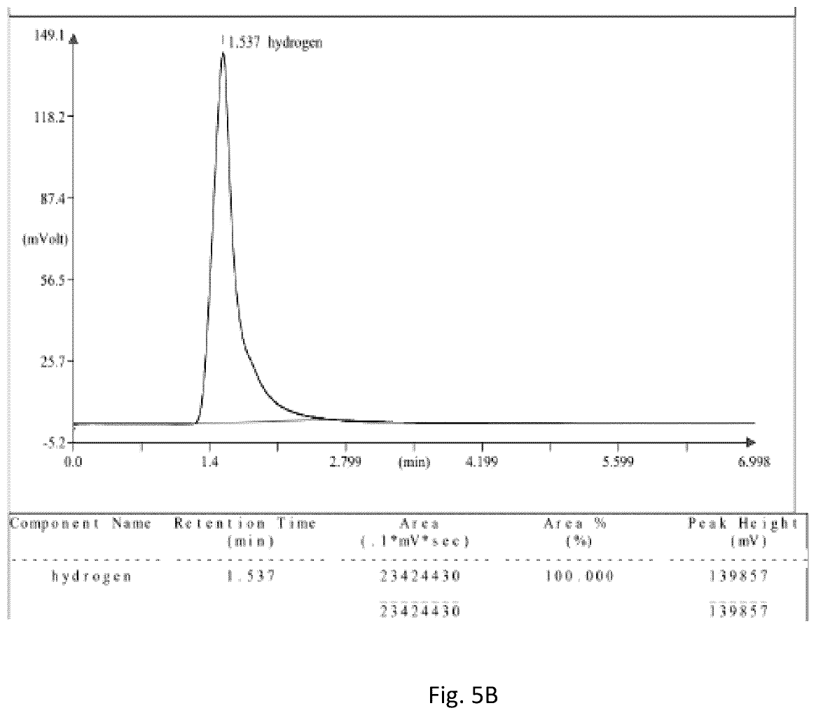

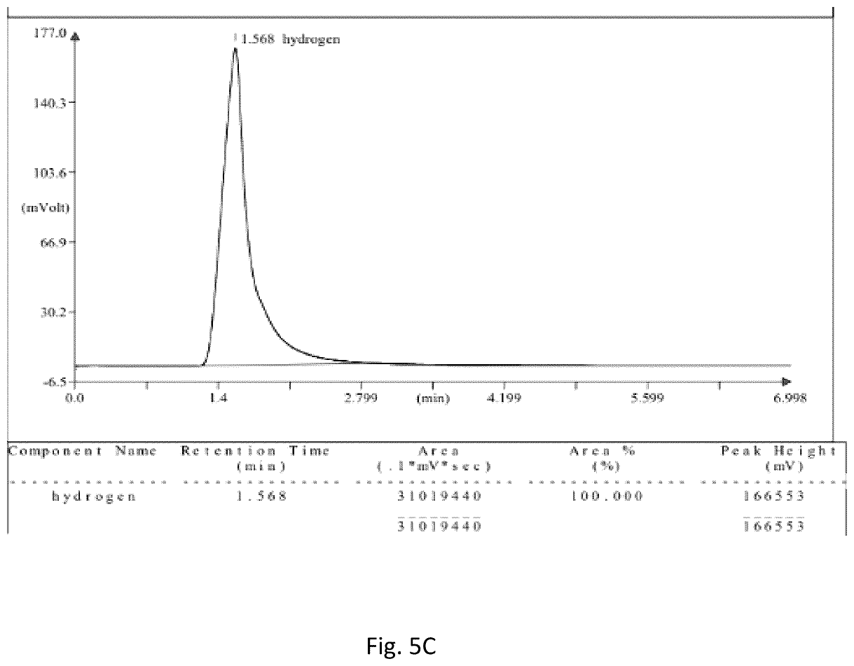

The gas flow rate obtained as also given in the table. Based on the results indicated in Table 2 above the conditions 4 V and 60 A were chosen for further studies. The results obtained are shown in FIG. 5A, FIG. 5B, and FIG. 5C. These figures include graphs showing GC analysis of gas samples collected during EO of sample 1 at different time. (FIG. 5A) Gas sample as soon as voltage applied (t=0 h), (FIG. 5B) Gas sample collected after 1 hour, (FIG. 5C) Gas sample collected at after 2 hours.

Table 3 shows the composition and flow rates of gas produced during EO of sample 1 at different time.

TABLE 3

| | | | | | | Molar |
|---|---|---|---|---|---|---|
| | | | | | | flow |
| | | Air | | | | rate of |
| Voltage | Current | Flowrate | Time | Concentration | Hydrogen | hydrogen |
| (V) | (A) | (m³/h) | (h) | of H₂ | flowrate(m³/h) | (mole/h) |
| 4 | 60 | 0.0133 | 0 | 41.994 | 0.0056 | 0.228 |
| | | | 1 | 58.880 | 0.0078 | 0.320 |
| | | | 2 | 80.022 | 0.0106 | 0.435 |

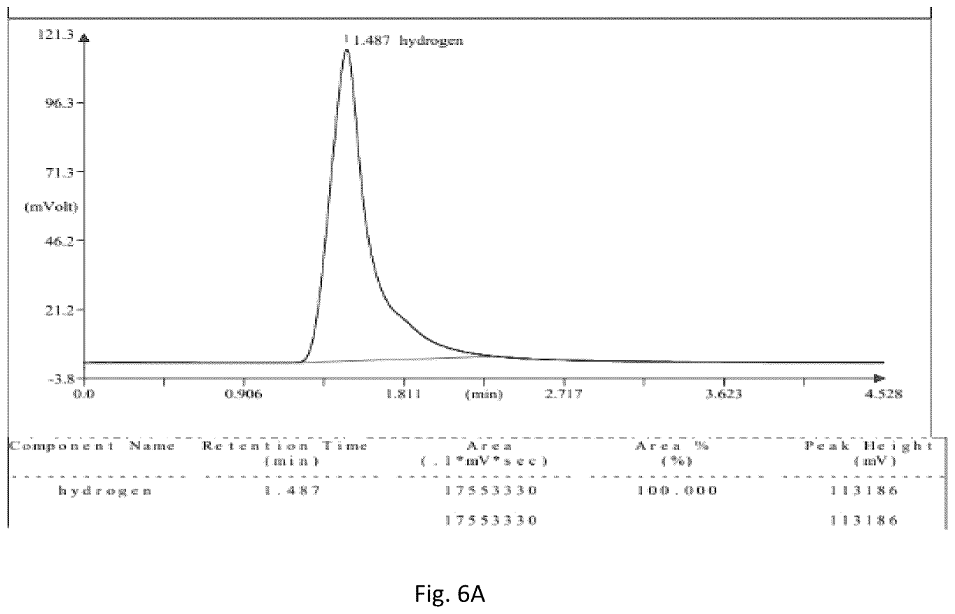

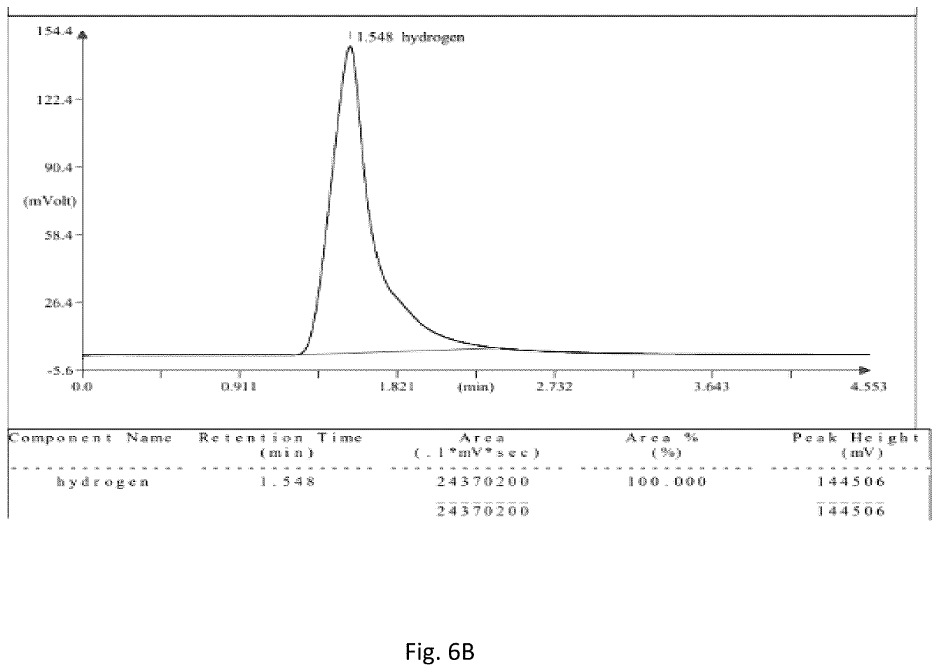

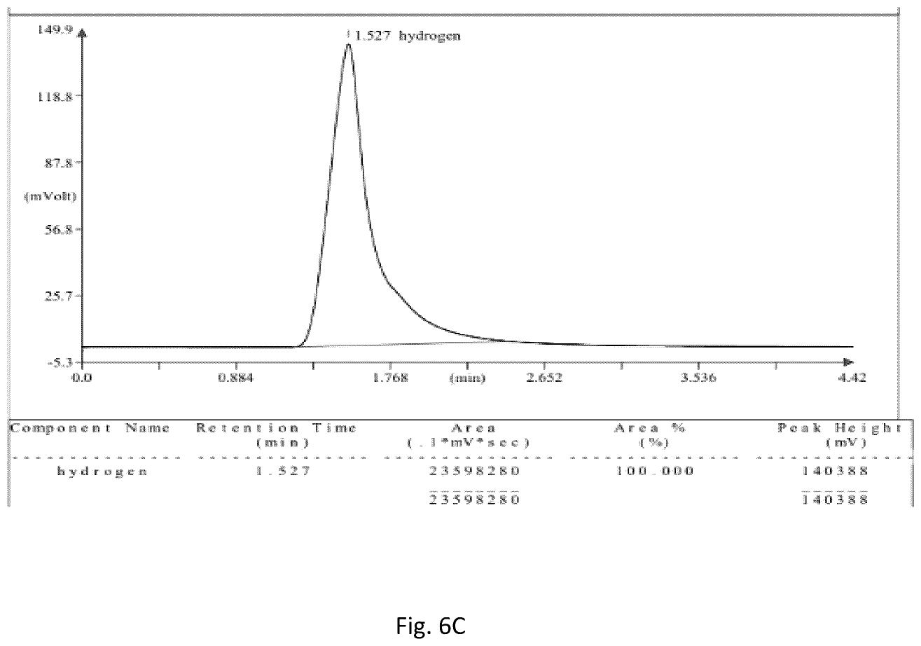

FIG. 6A, FIG. 6B, and FIG. 6C include graphs showing GC analysis of gas samples collected during EO of sample 2 at different time. (FIG. 6A) Gas sample as soon as voltage applied (t=0 h), (FIG. 6B) Gas sample collected after 1 hour, and (FIG. 6C) Gas sample collected at after 2 hours

Table 4 shows the composition and flow rates of gas produced during EO of sample 2 at different time.

TABLE 4

| | | | | | | Molar |
|---|---|---|---|---|---|---|
| | | | | | | flow |
| | | Air | | | | rate of |
| Voltage | Current | Flowrate | | Concentration | Hydrogen | hydrogen |
| (V) | (A) | (m³/h) | Timing | of H₂ | flowrate(m³/h) | (mole/h) |
| 4 | 60 | 0.0191 | 0 | 42.536 | 0.0081 | 0.332 |
| | | | 1 hr | 61.513 | 0.0117 | 0.480 |
| | | | 2 hr | 59.364 | 0.0113 | 0.464 |

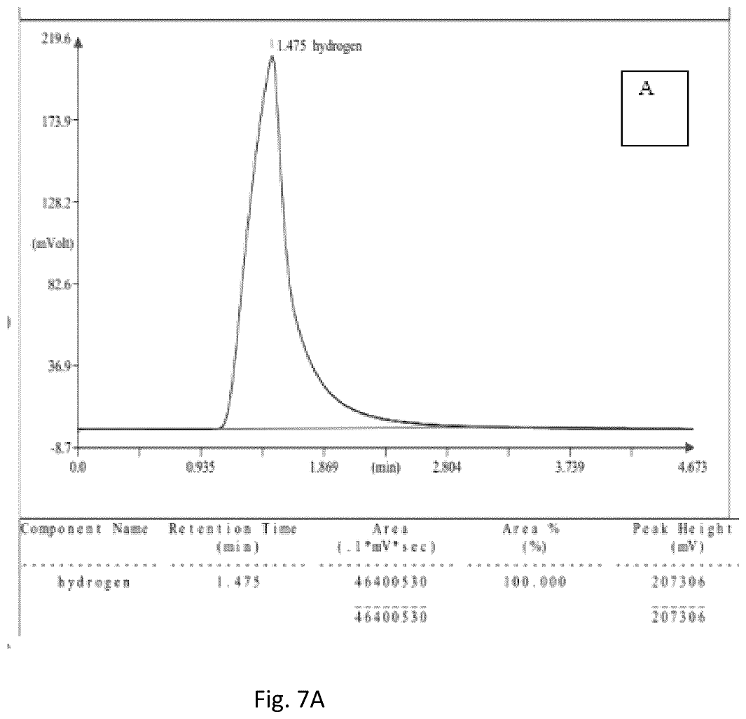

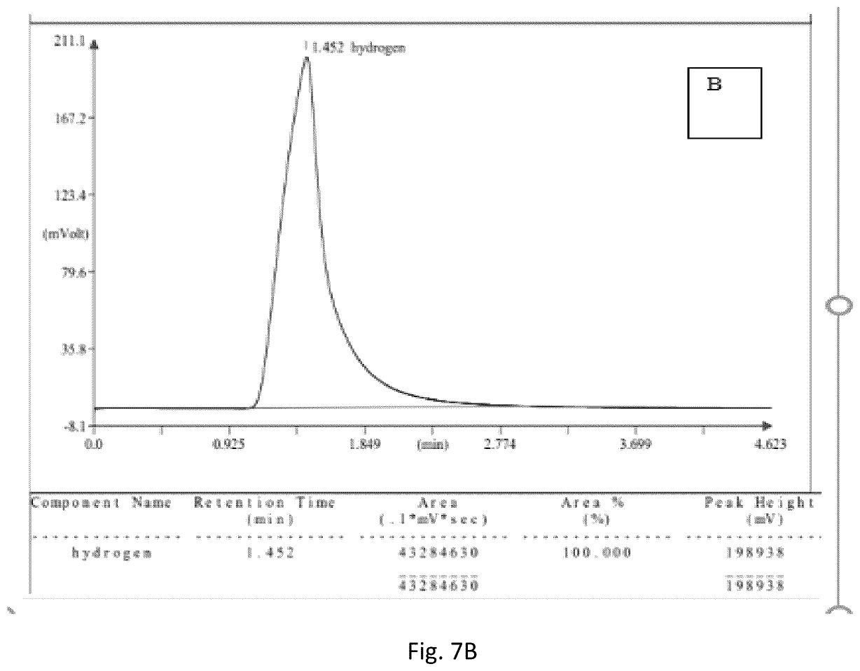

From Table 3 and FIGS. 5A, 5B, and 5C, it is noticed that, % hydrogen increases in the gas sample produced with EO duration. It is also noticed that during extended time of operation, the rectifier got heated up abnormally. Based on this, it was decided to reduce the operating current density below the rated level 25 mA/cm² of exposed cathode surface. However, the voltage was not reduced below 3.68. EO performed at this condition gave results as shown in FIG. 7A and FIG. 7B. These figures include GC analysis of (FIG. 7A) Hydrogen gas from sample 1, (FIG. 7B) Hydrogen gas from sample 2.

Table 5 shows the composition and flow rates of gas produced during EO of sample 1 & sample 2.

TABLE 5

| | | | | | | Molar |
|---|---|---|---|---|---|---|
| | | | | | | flow |
| | | | Air | | | rate of |
| Voltage | Current | | Flowrate | Concentration | Hydrogen | hydrogen |
| (V) | (A) | Samples | (m³/h) | of H₂ | flowrate(m³/s) | (mole/s) |
| 3.68 | 30 | Sample 1 | 0.0085 | 59.829 | 0.0051 | 0.208 |
| | | Sample 2 | 0.0117 | 55.721 | 0.0065 | 0.267 |

Under this condition also, hydrogen concentration maintained in the range of 55 to 60%. However, gas production rate reduced. It was observed that the rate of temperature raise decreased.

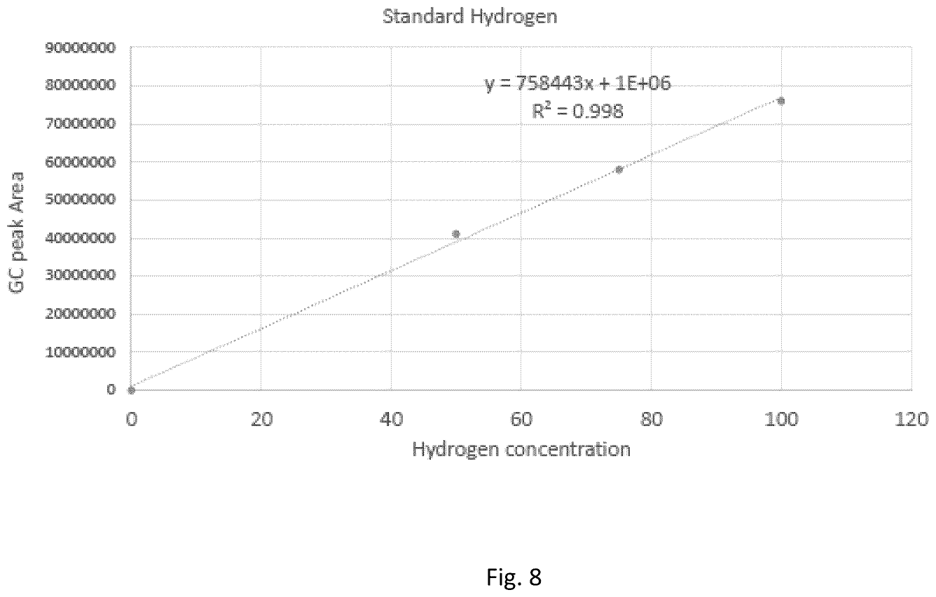

FIG. 8 shows a hydrogen gas calibration chart. Standard hydrogen is injected at different concentrations and analyzed in Gas Chromatography to get the Standard Hydrogen curve.

### Phase IIA Project Details

One of the effective ways of treating dissolved organics present in the effluent water from the petroleum industry is electro-oxidation and the electro-oxidation of effluent water produces hydrogen along with chlorine, oxygen and carbon dioxide. This phase aims to remove other gases and utilize hydrogen in a proton exchange membrane (PEM) fuel cell to generate electricity.

### Phase IIA Objectives and Specific Aims

The primary objective of this study is to generate electricity using hydrogen gas generated from the electro-oxidation of effluent water. The specific aims of this work are as follows:
Effective removal of impurities, such as chlorine, carbon dioxide and oxygen
Utilization of produced hydrogen to generate electricity
Technoeconomic analysis of the process

### Phase IIA Experimental

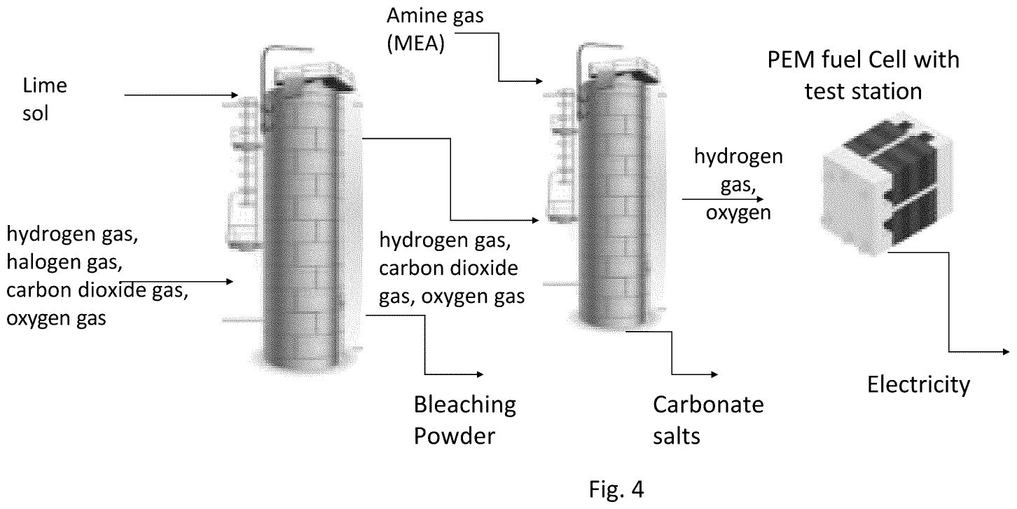

Effluent water containing dissolved organics is electro-oxidized by the methodology discussed in the phase IA, and various gases produced by the electro-oxidation of effluent water are scrubbed sequentially as shown in FIG. 4. The chlorine is converted into a value-added product, bleaching powder using lime column and carbon dioxide is scrubbed using monoethanolamine (MEA). The solubility of hydrogen is very low in lime and MEA, which ensures its retention for collection at the end. Following the removal of chlorine and carbon dioxide the traces of oxygen, if any, are separated using a membrane. The purified hydrogen is then directed into a 100 W liquid-cooled PEM fuel stack, where it undergoes electrochemical reactions to generate electricity. PEM fuel cell test stations regulate the flow, temperature, and pressure of the hydrogen gas, maintaining optimal conditions for the electricity generation (FIG. 4). This experimental approach establishes a sustainable method for hydrogen production from petroleum effluent water, emphasizing both environmental sustainability and potential commercial viability through valuable by-product generation.

In a first clause is disclosed a method comprising: (1) treating contaminated water, wherein treating contaminated water produces a gaseous byproduct that comprises hydrogen gas and at least one other gas; and (2) removing the at least one other gas from the gaseous byproduct to produce a hydrogen-rich gaseous product. In the method, the hydrogen-rich gaseous product may comprise hydrogen gas in an amount of 99% or more. In the method, the gaseous byproduct may comprise hydrogen gas and at least one other gas selected from: halogen gas or halogen-containing gas, oxygen gas, carbon dioxide gas, sulfur-containing gas, or any combinations thereof. In the method, wherein the gaseous byproduct may comprise hydrogen gas, halogen gas or a halogen-containing gas, carbon dioxide gas, and a sulfur-containing gas. In the method, treating the contaminated water may comprise removing water-soluble organics (WSOs) or water-soluble organic compounds (WSOCs) from contaminated water. In the method, the contaminated water may be a petroleum refining effluent (PRE). In the method, when the gaseous byproduct comprises halogen gas or halogen-containing gas, the halogen gas or halogen-containing may be removed using lime (CaO), soda lime (CaO and NaOH), activated alumina, or a mixture of calcium hydroxide and potassium hydroxide. In the method, when the gaseous byproduct comprises carbon dioxide gas, the carbon dioxide gas may be removed using an amine-containing material. In the method, when the gaseous byproduct comprises a sulfur-containing gas, the sulfur-containing gas may be removed using a caustic material. In the method, the hydrogen-rich gaseous product may be used as fuel for a device capable of producing electricity from the hydrogen-rich gaseous product.

In a second clause, a method is disclosed comprising: (1) treating a petroleum refining effluent (PRE), wherein treating petroleum effluent (PRE) produces a gaseous byproduct that comprises hydrogen gas, a halogen or halogen-containing gas, carbon dioxide gas, and a sulfur-containing gas; and (2) removing the halogen gas or halogen-containing gas, the carbon dioxide gas, and the sulfur-containing gas from the gaseous byproduct to produce a hydrogen-rich gaseous product; and (3) using the hydrogen-rich gaseous product to produce electricity. In the method, the halogen gas or halogen-containing gas may be removed using lime (CaO), soda lime (CaO and NaOH), activated alumina, or a mixture of calcium hydroxide and potassium hydroxide; the carbon dioxide gas may be removed using an amine-containing material; and the sulfur-containing gas may be removed using a caustic material. In the method, treating a petroleum refining effluent (PRE) may involve removal of water-soluble organics (WSOs) or water-soluble organic compounds (WSOCs) from the petroleum refining effluent (PRE) using an electro-oxidation process. In the method, the electricity may be used to power an electro-oxidation process.

In a third clause, a method is disclosed comprising: 1) treating a petroleum refining effluent (PRE), wherein treating petroleum refining effluent (PRE) produces a gaseous byproduct that comprises hydrogen gas, a halogen or halogen-containing gas, carbon dioxide gas, and a sulfur-containing gas; and (2) removing the halogen gas or halogen-containing gas, the carbon dioxide gas, and the sulfur-containing gas from the gaseous byproduct to produce a hydrogen-rich gaseous product; (3) using the hydrogen-rich gaseous product to produce electricity; and (4) using the electricity to power treating petroleum refining effluent (PRE). In the method, the halogen gas or halogen-containing gas may be removed using lime (CaO), soda lime (CaO and NaOH), activated alumina, or a mixture of calcium hydroxide and potassium hydroxide; the carbon dioxide gas may be removed using an amine-containing material; and the sulfur-containing gas may be removed using a caustic material. In the method, treating a petroleum refining effluent (PRE) may involve removal of water-soluble organics (WSOs) or water-soluble organic compounds (WSOCs) from the petroleum refining effluent (PRE) using an electro-oxidation process.

In a fourth clause, it is described a system comprising: (1) a subsystem configured for treating contaminated water, wherein a gaseous byproduct comprising hydrogen and at least one other gas is produced by treating the contaminated water; and (2) a subsystem configured for removing the at least one other gas from the gaseous byproduct to produce a hydrogen-rich gaseous product. In the system, it may further comprise a subsystem (3) configured to use the hydrogen-rich gaseous product to produce electricity. In the system, the system may be configured to use the electricity to power treating of the contaminated water. In the system, the subsystem configured for removing the at least one other gas from the gaseous byproduct to produce a hydrogen-rich gaseous product may comprise a unit configured for removing a halogen gas or a halogen-containing gas. In the system, the subsystem configured for removing the at least one other gas from the gaseous byproduct to produce a hydrogen-rich gaseous product may comprise a unit configured for removing carbon dioxide gas. In the system, the subsystem configured for removing the at least one other gas from the gaseous byproduct to produce a hydrogen-rich gaseous product may comprise a unit configured for removing sulfur-containing gas.

In a fifth clause, it is described a system comprising: (1) a subsystem configured for treating contaminated water, wherein a gaseous byproduct comprising hydrogen and at least one other gas is produced by treating the contaminated water; (2) a subsystem configured for removing the at least one other gas from the gaseous byproduct to produce a hydrogen-rich gaseous product; and (3) a subsystem configured to use the hydrogen-rich gaseous product to produce electricity. In the system, the system may be configured to use the electricity to power treating of the contaminated water. In the system, the subsystem configured for removing the at least one other gas from the gaseous byproduct to produce a hydrogen-rich gaseous product may comprise a unit configured for removing a halogen gas or a halogen-containing gas. In the system, the subsystem configured for removing the at least one other gas from the gaseous byproduct to produce a hydrogen-rich gaseous product may comprise a unit configured for removing carbon dioxide gas. In the system, the subsystem configured for removing the at least one other gas from the gaseous byproduct to produce a hydrogen-rich gaseous product may comprise a unit configured for removing sulfur-containing gas.

In a sixth clause, it is described a system comprising: (1) a subsystem configured for treating petroleum refining effluent (PRE), wherein a gaseous byproduct comprising hydrogen gas, a halogen gas or halogen-containing gas, and a sulfur-containing gas is produced by treating the petroleum refining effluent (PRE); (2) a subsystem configured for removing the halogen gas or the halogen-containing gas, and the sulfur-containing gas from the gaseous byproduct to produce a hydrogen-rich gaseous product; and (3) a subsystem configured to use the hydrogen-rich gaseous product to produce electricity. In the system, the subsystem for treating petroleum refining effluent (PRE) may comprise one or more pairs of Ti-containing electrodes. At least one of the one or more pairs of Ti-containing electrodes may comprise an anode coated with a mixed metal oxide. In the system, the subsystem configured for removing the halogen gas or the halogen-containing gas, and the sulfur-containing gas from the gaseous byproduct to produce a hydrogen-rich gaseous product may comprise a unit configured for removing the halogen gas or halogen-containing gas. The unit configured for removing the halogen gas or halogen-containing gas may comprise lime (CaO), soda lime (CaO and NaOH), activated alumina, or a mixture of calcium hydroxide and potassium hydroxide. In the system, the subsystem configured for removing the halogen gas or the halogen-containing gas, and the sulfur-containing gas from the gaseous byproduct to produce a hydrogen-rich gaseous product may comprise a unit configured for removing the carbon dioxide gas. The unit configured for removing carbon dioxide gas may comprise an amine-containing material. In the system, a subsystem configured for removing the halogen gas or the halogen-containing gas, and the sulfur-containing gas from the gaseous byproduct to produce a hydrogen-rich gaseous product may comprise a unit configured for removing the sulfur-containing gas. The unit configured for removing sulfur-containing gas may comprise a caustic material. In the system, the subsystem configured to use the hydrogen-rich gaseous product to produce electricity may comprise a hydrogen fuel cell.

1. A method comprising:
treating contaminated water, wherein treating contaminated water produces a gaseous byproduct that comprises hydrogen gas and at least one other gas; and
removing the at least one other gas from the gaseous byproduct to produce a hydrogen-rich gaseous product.

2. The method of claim 1, wherein the hydrogen-rich gaseous product comprises hydrogen gas in an amount of 99% or more.

3. The method of claim 1, wherein the gaseous byproduct comprises hydrogen gas and at least one other gas comprising halogen gas or halogen-containing gas, oxygen gas, carbon dioxide gas, sulfur-containing gas, or any combinations thereof.

4. The method of claim 3, wherein the gaseous byproduct comprises hydrogen gas, halogen gas or a halogen-containing gas, carbon dioxide gas, and a sulfur-containing gas.

5. The method of claim 1, wherein treating the contaminated water comprises removing water-soluble organics from the contaminated water.

6. The method of claim 5, wherein the contaminated water is petroleum refining effluent (PRE).

7. The method of claim 3, wherein the gaseous byproduct comprises halogen gas or halogen-containing gas, and the halogen gas or halogen-containing is removed using lime (CaO), soda lime (CaO and NaOH), activated alumina, or a mixture of calcium hydroxide and potassium hydroxide.

8. The method of claim 3, wherein the gaseous byproduct comprises carbon dioxide gas, and the carbon dioxide gas is removed using an amine-containing material.

9. The method of claim 3, wherein the gaseous byproduct comprises a sulfur-containing gas, and the sulfur-containing gas is removed using a caustic material.

10. The method of claim 1, wherein the hydrogen-rich gaseous product is used as fuel for a device capable of producing electricity from the hydrogen-rich gaseous product.

11. A method comprising:
treating petroleum refining effluent (PRE), wherein treating a petroleum refining effluent (PRE) produces a gaseous byproduct that comprises hydrogen gas, a halogen gas or halogen-containing gas, carbon dioxide gas, and a sulfur-containing gas;
removing the halogen gas or halogen-containing gas, the carbon dioxide gas, and the sulfur-containing gas from the gaseous byproduct to produce a hydrogen-rich gaseous product; and
using the hydrogen-rich gaseous product to produce electricity.

12. The method of claim 11, wherein:
the halogen gas or halogen-containing gas is removed using lime (CaO), soda lime (CaO and NaOH), activated alumina, or a mixture of calcium hydroxide and potassium hydroxide;
the carbon dioxide gas is removed using an amine-containing material; and
the sulfur-containing gas is removed using a caustic material.

13. The method of claim 11, wherein treating a petroleum refining effluent (PRE) comprises removal of water-soluble organics from the petroleum refining effluent (PRE) using an electro-oxidation process.

14. The method of claim 13, wherein the electricity is used to power the electro-oxidation process.

15. A system comprising:
a subsystem configured for treating contaminated water, wherein a gaseous byproduct comprising hydrogen and at least one other gas is produced by treating the contaminated water; and
a subsystem configured for removing the at least one other gas from the gaseous byproduct to produce a hydrogen-rich gaseous product.

16. The system of claim 15, further comprising a subsystem configured to use the hydrogen-rich gaseous product to produce electricity.

17. The system of claim 16, wherein the system is configured to use the electricity to power treating of the contaminated water in the subsystem configured for treating contaminated water.

18. The system of claim 15, wherein the subsystem configured for removing the at least one other gas from the gaseous byproduct to produce a hydrogen-rich gaseous product comprises a unit configured for removing a halogen gas or a halogen-containing gas.

19. The system of claim 15, wherein the subsystem configured for removing the at least one other gas from the gaseous byproduct to produce a hydrogen-rich gaseous product comprises a unit configured for removing carbon dioxide gas.

20. The system of claim 15, wherein the subsystem configured for removing the at least one other gas from the gaseous byproduct to produce a hydrogen-rich gaseous product comprises a unit configured for removing sulfur-containing gas.
